(19) United States
(12) Patent Application Publication
(10) Pub. No.: US 2003/0145035 A1
(43) Pub. Date: Jul. 31, 2003

(54) Method and system of protecting shared resources across multiple threads

(76) Inventor: Jeremy S. de Bonet, N. Andover, MA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/345,067

(22) Filed: Jan. 15, 2003

Related U.S. Application Data
(60) Provisional application No. 60/348,707, filed on Jan. 15, 2002.
(60) Provisional application No. 60/349,424, filed on Jan. 18, 2002.
(60) Provisional application No. 60/349,344, filed on Jan. 18, 2002.

(51) Int. Cl. G06F 9/00

(52) U.S. Cl. 709/102

(57) ABSTRACT

A method is disclosed for controlling access to a shared resource which can receive concurrent access requests for any shared resource from different application threads. This resource access manager can manage thread synchronization mechanisms for each of the shared resources to eliminate the possibility of data corruption or deadlock when multiple accesses to the same shared resource are performed. Further, a method for creating a multiple resource manager which controls access to many shared resources is disclosed. The multiple resource manager allows threads to request access to resources via name, number or other identifier, and routes these accesses to the resource access manager associated with the shared resource. The code for the resource access manager and multiple resource manager may be implemented as a class within a library of classes to allow programmers to use the class without having to know all the details of its inner workings.

### FIELD OF THE INVENTION

The invention relates in general to protecting resources, and more particularly, to methods and systems of protecting shared resources across a plurality of threads.

### DESCRIPTION OF THE RELATED ART

Computer programs and applications often contain multiple threads which execute simultaneously. Each of the plurality of threads within a multithreaded computer programs might need access to manipulate one or more resources which are shared by the executing threads. Simultaneous access by different threads to any of the shared resources may lead to data corruption, and potentially to failure of the entire program.

The following example demonstrates how corruption can occur even for one simplest types of shared resources: a simple counter. Suppose a multithreaded program has two threads, A and B, which access a shared counter. Unless precautions are taken, simultaneous access to this counter can cause inadvertent corruption. If thread A attempts to increment the counter, say from 89 to 90, while thread B is simultaneously trying to increase the counter by 10, from 89 to 99, one or both of these operations could be lost, depending on how the thread execution is scheduled by the operating system. If, while attempting to increment the counter, thread A is interrupted by thread B after it has read the value of the counter, thread B will change the counter to 99, but when thread A resumes it will set the value to 90, which is the value it original read (89) plus 1. With different execution schedules, different results can occur, only some of which yield the correct result of 100.

Such errors can be difficult to track down. Programmers may spend significant amounts of time trying to debug code that does not have a problem.

In conventional systems, thread synchronization techniques such as mutexes and semaphores are used to reduce the likelihood of shared resource corruption. However, no general technique is known that alleviates the programmer of the burden of handling such synchronization, particularly for relatively lower-level programming languages, such as C, C++, and the like.

### SUMMARY OF THE INVENTION

Embodiments of the present invention provide a method and system for controlling access to a shared resource which prevents the inadvertent corruption of these resources in a multithread environment.

In certain embodiments a resource manager may use a thread synchronization primitive to control access to a shared resource.

In other embodiments a single multiple resource manager can be used to control access to a plurality of resources. This multiple resource manager is particularly well suited for systems which support third-party plug-in modules.

In more specific embodiments, a resource access manager is implemented as a class within a library of classes to allow programmers to use the class without having to known all the details of its implementation. Within this preferred embodiment each of the shared resources can be individually referred to by a name, number, or other identifier.

In some embodiments, the use of a mutex as a thread synchronization primitive allows read, write, and adjustment operations to occur synchronously

In other embodiments, a semaphore, a more sophisticated thread synchronization primitive, can be used to allow read-only operations to occur simultaneously.

In still another set of embodiments, a multithreaded system which comprises a plurality of shared resources can also comprise a plurality of software modules that each enable a different application. The system can also comprise one or more resources that can be accessed by at least two of the different applications within a single multithreaded program, wherein each of those at least two different applications is adapted to have its own thread or threads that use the resources. The system can further comprise a resource access manager software module that is adapted to control each threads' access to a resource. The system can further comprise a multiple resource manager software module that controls when each thread can have access to some or all of a plurality of shared resources.

In a further set of embodiments, data processing system readable media can comprise code that includes instructions for carrying out the methods described and may be used on the systems.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a computer that can be used in an embodiment of the present invention.

FIG. 2 includes an illustration of a data processing system storage medium including software code having instructions in accordance with an embodiment of the present invention.

FIG. 3 includes an illustration of one embodiment of the software architecture for a resource access manager.

FIG. 4 includes an illustration of one embodiment of the software architecture for a multiple resource manager.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Embodiments of the present invention provide a software system in which a resource access manager prevents the inadvertent corruption of resources shared by multiple threads. This resource access manager provides thread synchronization mechanisms for a shared resource to eliminate the possibility of the resource being corrupted when simultaneously accessed by a plurality of program threads.

In some embodiments access management for a plurality of resources can be controlled by a single multiple resource manager. The multiple resource manager is particularly well suited for computer programs which support the integration of software plug-in modules, potentially written by third-parties.

In some embodiments, read, write, and adjustment operations are forced to occur synchronously. In other embodiments, more sophisticated thread synchronization techniques can be used which can allow read-only operations to occur simultaneously.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “software component” is intended to mean at least a portion of a computer program (i.e., a software application). An example includes a software module as used in object-oriented programming. Different software components may reside in the same computer program or in different computer programs on the same computer or different computers.

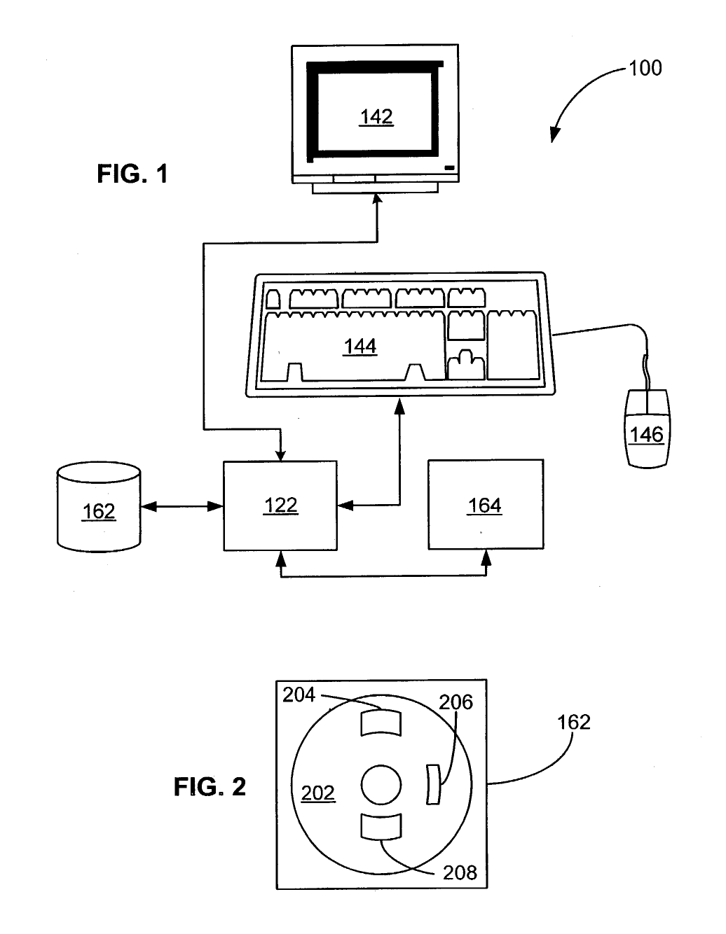

Before discussing embodiments of the present invention, an exemplary hardware architecture for using embodiments of the present invention is described. FIG. 1 illustrates such an exemplary hardware architecture and includes computer system 100 comprising central processing unit (“CPU”) 122. CPU 122 may comprise read-only memory (“ROM”), random access memory (“RAM”), or other types of volatile or non-volatile memory. CPU 122 is bi-directionally coupled to monitor 142, keyboard 144, hard disk (“HD”) 162, and printer 164. An electronic pointing device, such as mouse 146, may be coupled to CPU 122 directly (not shown) or via keyboard 144. Other electronic pointing devices can include a trackball, stylus, or the like and may replace or be used in conjunction with mouse 146.

Note that FIG. 1 is a simplification of an exemplary hardware configuration. Computer system 100 may have more than one of hardware components shown in FIG. 1. In addition, other peripheral devices (not shown) may be coupled to CPU 122 or other portion(s) of the computer system 100. Many other alternative hardware configurations are possible and known to skilled artisans.

CPU 122 is an example of a data processing system. HD 162, ROM, RAM, and other memories can include media that can be read by the CPU 122. Therefore, each of these types of memories includes a data processing system readable medium.

Portions of the methods described herein may be implemented in suitable software code that may reside within HD 162, ROM, RAM, or other memory. The instructions in an embodiment of the present invention may be contained on HD 162 or other memory. FIG. 2 illustrates a combination of software code elements 204, 206, and 208 that are embodied within a data processing system readable medium 202 on HD 162. Alternatively, the instructions may be stored as software code elements on a DASD array, magnetic tape, floppy diskette, optical storage device, or other appropriate data processing system readable medium or storage device.

In an illustrative embodiment of the invention, the computer-executable instructions may be lines of compiled assembly, C, C⁺⁺, Java, or other language code. Other architectures may be used. A computer program or its software components with such code may be embodied in more than one data processing system readable medium in more than one computer.

Communications using computer system 100 in FIG. 1 can be accomplished using electronic, optical, radio-frequency, or other signals. For example, when a user is at computer system 100, CPU 122 may convert the signals to a human understandable form when sending a communication to the user and may convert input from the user to appropriate electronic, optical, radio-frequency, or other signals to be used by, other computer systems (not shown).

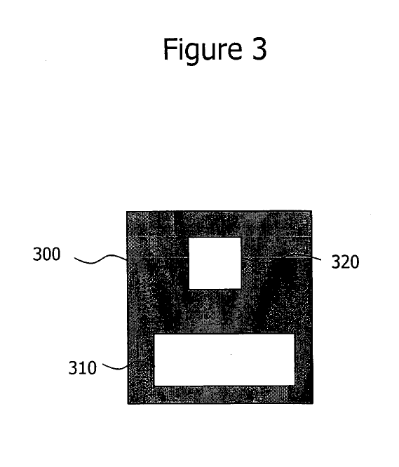

Attention is now directed to the software architecture of the software in accordance with one embodiment of the present invention. The software architecture is illustrated in FIG. 3. A basic idea behind the architecture is to have a resource manager control the access which multiple program threads have to shared resources to prevent data corruption due to concurrent access. The shared resources may include a clock, a counter, a character string, a database, a structured file (an extensible markup language document), an unstructured file (an image file, audio file, or the like), or the like. Therefore, the types of shared resources may be highly varied.

Turning now to FIG. 3 a resource access manager of the present invention is depicted. Often times, computer programs contain different threads. These threads, which usually execute simultaneously, need access to resources such as those described above to perform properly. However, the shared access these threads have to these resources can cause a myriad number of problems, the most pertinent of which is data corruption and deadlock. Consequently, the present invention provides a resource access manager 300 which prevents the inadvertent corruption of resources shared by multiple threads. This resource access manager 300 provides thread synchronization mechanisms for a shared resource 310 to eliminate the possibility of the resource being corrupted when simultaneously accessed by a plurality of program threads. Further, this resource access manager is designed so that deadlock cannot occur.

A shared resource 310 may be a clock, counter, data, character strings, clocks, data objects, and the like needed by a thread, or by multiple threads or applications. However, as elaborated on above, when threads simultaneously access this shared resource 310, corruption can occur. To combat this problem, a resource access manager 300 is associated with a shared resource 310.

Resource access manager 300 receives a request from a thread that wishes to access shared resource 310 associated with resource access manager 300. Resource access manager 300 controls this access to shared resource 310 through use of thread synchronization primitive 320, examples of which are a mutex and a semaphore.

In some embodiments, a mutex can be used by resource access manager 300 to control both read and write access to a shared resource 310. A mutex is a thread synchronization object provided by most modern operation systems, which allows only one thread to lock the mutex at any given time. If a thread tries to lock a mutex which is currently locked, commonly known as “owned” by some other thread, the thread blocks until the mutex is unlocked. Whenever a thread requests access to the resource, via any of the access functions, the thread attempts to lock the resource's mutex. If the resource is currently being accessed, then the thread blocks until the resource is available again. When no other thread is currently accessing the resource, the lock is granted, the access function is performed, and then the mutex is unlocked. This embodiment has the advantage of being simple to implement, however, only one thread may access the resource at a time, even under conditions when several threads could safely have access to the resource simultaneously. A flow diagram for a mutex can be described as:

```
START: Access request from some thread
  |
Is mutex locked?
  | \grave{ }- - (yes) - > block until_free
  |
(no)
  |
Lock mutex
  |
Perform access function
  |
Unlock mutex
  |
END: Access completed
```

In other embodiments, semaphores can be used by resource access manager 300 to control read- and write-access. In addition to the lock/unlock operation supported by mutexes, semaphores support an additional claim/release operation. Any number of threads can have claims to a semaphore, however, no thread can lock a semaphore until all claims have been released. Likewise, no thread can obtain a claim to a semaphore while it is locked. Finally, just like a mutex, only one thread can lock a semaphore at a time.

Thus, when using semaphores to control access to shared resource 310, resource access manager 300 may issue claims to the semaphore associated with a resource to any number of threads, but no more than one thread can lock a resource's semaphore at any time. When a thread attempts to perform a read-operation, an attempt is made to gain a claim to the resource's semaphore. When the read-operation has completed the claim is released. When a thread attempts to perform a write operation, the thread is blocked until there are no claims pending, at which point the write operation can take place. This embodiment has the advantage that multiple threads may access the resource at a time. A flow diagram for a semaphore can be described as:

| START: Access request from some thread | |
|---|---|
| \| | |
| Is semaphore locked? | |
| \| \| | |
| \| \grave{ }- - (yes) - > block until free | |
| \| | |
| (no) | |
| \| | |
| Is it a read operation? | |
| \| \| | |
| \| \grave{ }- - (yes) - > claim semaphore | |
| \| \| | |
| (no) | Perform read-access operation |

| | |
|---|---|
| \| | \| |

| | |
|---|---|
| \| | release semaphore |

| | |
|---|---|
| \| | \| |

| | |
|---|---|
| \| | goto END |

```
  |
Is semaphore claimed?
  | |
  | - - (yes) - > block until no claims
  |
(no)
|
Lock Semaphore
  |
Perform write-access function
|
Unlock Semaphore
|
END: Access completed
```

Resource access manager 300 then allows the calling thread to access shared resource 310 according to the protocol dictated by thread synchronization primitive 320.

Utilizing a resource access manager 300 allows controlling access to shared resource 320 to be moved out of a computer program or thread and into resource access manager 300. To facilitate this process, resource access manager 300 and thread synchronization primitive 320 may be part of a class as that term is used in object-oriented programming. This class may be a class within a library of classes that are provide to programmers, so that a programmer does not need to write his or her own code any time a call to a shared resource is made. For example,

#include “shared_res_mgr.h”

may be used to invoke this class.

Instead of functions, such as “cin” and “cout” as with the with the C++ programming language's iostream class, the functions in the resource access manager class may comprise “install,” “uninstall,” “get,” “set,” “adjust,” and “unset.” The class is particularly well suited for networked computers that communicate using Simple Network Management Protocol. Note that other names may be used for the functions, such as “retrieve” for “get,” “delete” for “unset,” and the like.

The functions performed by resource access manager 300 may be classified as read operations, write operations, or a combination of read and write operations. A read operation may be triggered by a “get” command. A write operation may be triggered by an “install”, “uninstall”, “set”, or “unset” command. An “adjust” command may include both a read operation and a write operation.

The “install” and “uninstall” functions may be used for adding or deleting a shared resource 310. The “get” function may be used to read or otherwise obtain a value or other data from shared resource 310. The “set” function may be used to initialize or reset shared resource 310 to a particular value. In one embodiment, the “set” function may set a counter to a value regardless of what value was previously in the counter. For example, a set function of “27” to a counter may set the counter to 27 regardless of the value that was previously in the counter

The “unset” function may delete the data in shared resource 310. The “adjust” function can be similar to the “set” function but change data on a relative basis based on the pre-existing value(s) in shared resource 310. For example, an “adjust” function of “+1” sent to a counter may increment the pre-existing value in the count by one. If the counter already had a value of 27 before the adjust function, the value after the adjust function would be 28.

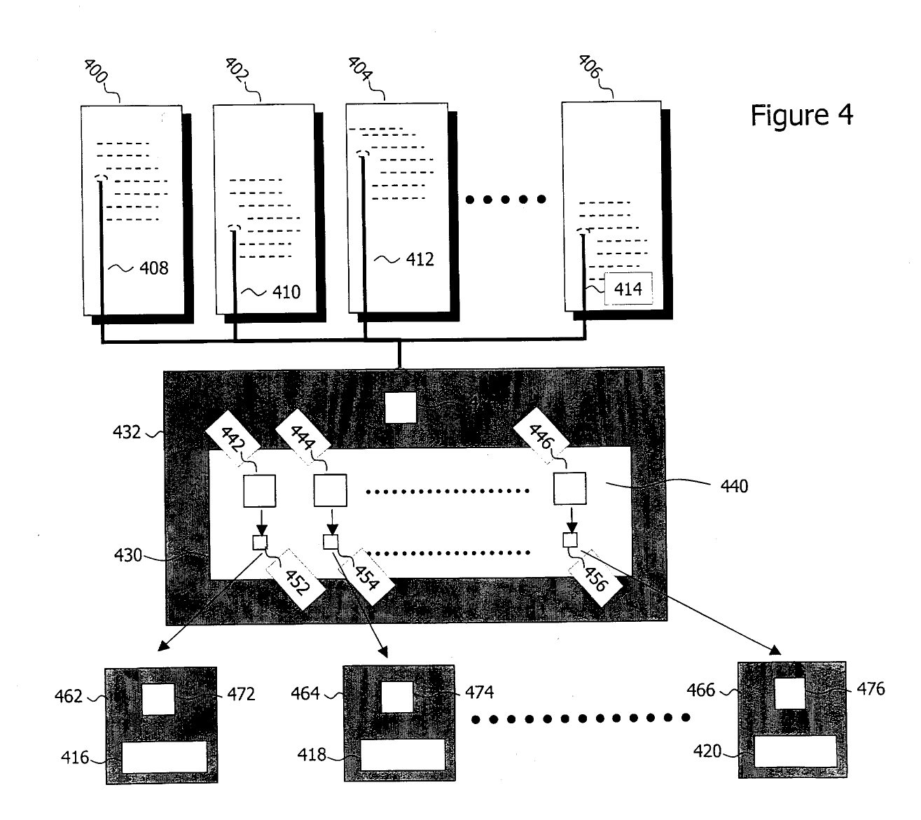

Moving on to FIG. 4, one embodiment of the present invention which manages access to multiple shared resources is depicted. In one embodiment, the access management for a plurality of resources can be combined into a single multiple resource manager 430. In this particular embodiment, access to any shared resource 416 418, 420 managed by resource manager 430 can be requested by any thread 400, 402, 404, 406 at any time. When access is requested the individual resource access manager 462, 464, 466 for that shared resource 416, 418, 420 controls the access to that resource 416, 418, 420. This arrangement allows for the creation, removal, or replacement of resources at any time by any thread. Further, it provides a mechanism for software plug-in modules to gain access and share resources without modification of the original program.

Threads 400, 402, 404, 406 of a computer program or application send out access requests 408, 410, 412, 414 for various shared resources 416, 418, 420. These access requests 408, 410, 412, 414 can be routed to multiple resource manager 430. Occasionally, the access requests 408, 410, 412, 414 by threads 400, 402, 404, 406 or programs cannot be handled simultaneously by the multiple resource manager 430, for example multiple “install” or “uninstall” calls. In these cases, access to multiple resource manager 430 must itself be controlled. Controlling access to multiple resource manager 430 is done by associating a resource access manager 432 with the entire multiple resource manager 430. In this manner, access to multiple resource manager 430 can be regulated according to the protocol dictated by the thread synchronization primitive 434 utilized by resource access manager 432 as described above.

Multiple resource manager 430 then receives the resource access requests 408, 410, 412, 414 issued by threads 400, 402, 404, 406. Typically, because shared resources 416, 418, 420 are utilized and referred to in many threads and programs, individual resources are referred to by an identifier, which may be a name, number, pointer or other mechanism. Consequently, multiple resource manager 430 may contain lookup table 440, commonly implemented as an associative array, trie, hash table, or the like, which links an identifier 442, 444, 446 of a shared resource to a pointer 452, 454, 456.

Each pointer 452, 454, 456 indicates the location of the resource access manager 462, 464, 466 associated with the shared resource 416, 418, 420, referred to by the identifier 442, 444, 446. Once the resource access manager 462, 464, 466 for the shared resource 416, 418, 420 is located, a resource access request 408, 410, 412, 414 regarding that shared resource 416, 418, 420 can be routed to the resource access manager 462, 464, 466, for that particular shared resource 416, 418, 420. This resource access request 408, 410, 412, 414, can then be handled by that individual resource access manager 462, 464, 466, according to the corresponding thread synchronization primitive 472, 474, 478 as described above.

The methods and systems described have many advantages over conventional methods and systems. More particularly, the code necessary for performing the function calls as described may be part of a class located within a library of classes available to users of programming languages, such as C, C⁺⁺, and the like. Therefore, programmers in those languages who use these classes may not need to know and understand all of the inner workings necessary to properly synchronize and perform function calls in an orderly manner to eliminate the possibility of data corruption or deadlock when multiple threads from different applications are attempting to use the same resource during the same time period.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A method of synchronizing access to a shared resource comprising:
associating a resource access manager with the shared resource, wherein the resource access manager includes a thread synchronization primitive;
receiving a request from a thread for the shared resource at the resource access manager; and
allowing the thread to access the shared resource according to the thread synchronization primitive.

2. The method of claim 1, wherein the thread synchronization primitive is a mutex.

3. The method of claim 2, further comprising:
blocking the thread until the mutex is free;
locking the mutex;
performing the request; and
unlocking the mutex.

4. The method of claim 3, further comprising releasing the shared resource.

5. The method of claim 1, wherein the thread synchronization primitive is a semaphore.

6. The method of claim 5, further comprising:
blocking the thread until the semaphore is free;
claiming the semaphore, performing the request, releasing the semaphore, if the request is a read; and
blocking the thread until no claims exist, locking the semaphore, performing the request, unlocking the semaphore, if the request is a write.

7. The method of claim 1 further comprising releasing the shared resource.

8. A data processing system readable medium, comprising code containing instructions translatable for:
associating a resource access manager with the shared resource, wherein the resource access manager includes a thread synchronization primitive;
receiving a request from a thread for the shared resource at the resource access manager; and
allowing the thread to access the shared resource according to the thread synchronization primitive.

9. The data processing system readable medium of claim 8, wherein the thread synchronization primitive is a mutex.

10. The data processing system readable medium of claim 9, herein the code further comprises instructions translatable for:
blocking the thread until the mutex is free;
locking the mutex;
performing the request; and
unlocking the mutex.

11. The data processing system readable medium of claim 10, wherein the code further comprises instructions translatable for releasing the shared resource.

12. The data processing system readable medium of claim 8, wherein the thread synchronization primitive is a semaphore.

13. The data processing system readable medium of claim 12, wherein the code further comprises instructions translatable for:
blocking the thread until the semaphore is free;
claiming the semaphore, performing the request, releasing the semaphore, if the request is a read; and
blocking the thread until no claims exist, locking the semaphore, performing the request, unlocking the semaphore, if the request is a write.

14. The data processing system readable medium of claim 12, further comprising releasing the shared resource.

15. A system for the protection of a shared resource, comprising:
a software component configured to:
receive a request from a thread for the shared resource; and
allow the thread to access the shared resource according to a thread synchronization primitive.

16. The method of claim 15, wherein the thread synchronization primitive is a semaphore.

17. The method of claim 16, wherein the software component is further configured to:
block the thread until the mutex is free;
lock the mutex;
perform the request; and
unlock the mutex.

18. The method of claim 17, further comprising releasing the shared resource.

19. The method of claim 15, wherein the thread synchronization primitive is a semaphore.

20. The method of claim 19, wherein the software component is further configure to:
block the thread until the semaphore is free;
claim the semaphore, perform the request, release the semaphore, if the request is a read; and
block the thread until no claims exist, lock the semaphore, perform the request, unlock the semaphore, if the request is a write.

21. The method of claim 20, further comprising releasing the shared resource.

22. A system for managing resource access, comprising:
a plurality of shared resources;
a plurality of resource access managers, wherein each resource access manager comprises:
an associated shared resource; and
a thread synchronization primitive; wherein access to the shared resource is controlled by the thread synchronization primitive of the associated resource access manager; and
a multiple resource manager, the multiple resource access manager comprising a table linking each shared resource with the associated resource access manager.

23. The system of claim 22, wherein:
the multiple resource manager receives a request for one shared resource from a thread, links the one shared resource with the associated resource access manager and sends the request to the associated resource access manager; and
the associated resource access manager receives the request from the multiple resource manager and allows the thread access to the one shared resource according to the thread synchronization primitive of the associated resource access manager.

24. The system of claim 23, wherein each thread synchronization primitive is either a mutex or a semaphore.

25. The system of claim 24, for each thread synchronization primitive that is a mutex, access is controlled as follows:
the thread is blocked until the mutex is free;
the mutex is locked;
the request performed; and
the mutex unlocked.

26. The system of claim 24, for each thread synchronization primitive that is a semaphore, access is controlled as follows:
the thread is blocked until the semaphore is free;
the semaphore is claimed, the request performed, the semaphore released, if the request is a read; and
the thread blocked until no claims exist, the semaphore locked, the request performed, the semaphore unlocked, if the request is a write.

27. The system of claim 24, further comprising an additional shared resource manager associated with the multiple resource manager, wherein the additional shared resource manager comprises an additional thread synchronization primitive that controls access to the multiple resource access manager.

28. The system of claim 27, wherein the additional thread synchronization primitive is either a mutex or a semaphore.

29. The system of claim 28, wherein the additional thread synchronization primitive is a mutex and access to the multiple resource manager is controlled as follows:
the thread is blocked until the mutex is free;
the mutex is locked;
the request performed; and
the mutex unlocked.

30. The system of claim 28, wherein the additional thread synchronization primitive that is a semaphore and access to the multiple resource manager is controlled as follows:
the thread is blocked until the semaphore is free;
the semaphore is claimed, the request performed, the semaphore released, if the request is a read; and
the thread blocked until no claims exist, the semaphore locked, the request performed, the semaphore unlocked, if the request is a write.

31. The system of claim 22, wherein the table further comprises an array linking a name of each shared resource to the particular resource access manager associated with that shared resource.

32. A method of managing access to shared resources, comprising:
receiving at a multiple resource manager request from a thread for one of a plurality of shared resources;
identifying a particular resource access manager associated with the called shared resource;
forwarding the request from the multiple resource manager to the identified resource access manager;
receiving the request at the identified resource access manager; and
allowing the thread access to the called shared resource according to a thread synchronization primitive contained within the identified resource access manager.

33. The method of claim 32, wherein the thread synchronization primitive is a mutex.

34. The method of claim 33, further comprising:
blocking the thread until the mutex is free;
locking the mutex;
performing the request; and
unlocking the mutex.

35. The method of claim 34, further comprising releasing the shared resource.

36. The method of claim 32, wherein the thread synchronization primitive is a semaphore.

37. The method of claim 36, further comprising:
blocking the thread until the semaphore is free;
claiming the semaphore, performing the request, releasing the semaphore, if the request is a read; and
blocking the thread until no claims exist, locking the semaphore, performing the request, unlocking the semaphore, if the request is a write.

38. The method of claim 37, further comprising releasing the shared resource.
